(19) United States
(12) Patent Application Publication
(10) Pub. No.: US 2010/0289851 A1
(43) Pub. Date: Nov. 18, 2010

(54) METHOD FOR MAINTAINING FLUID EJECTING APPARATUS, AND FLUID EJECTING APPARATUS

(75) Inventor: Eiichiro WATANABE, Matsumoto-shi (JP)

Correspondence Address: WORKMAN NYDEGGER;1000 Eagle Gate Tower, 60 East South Temple, Salt Lake City, UT, 84111, US

(73) Assignee: SEIKO EPSON CORPORATION, Tokyo (JP)

(21) Appl. No.: 12/781,094

(22) Filed: May 17, 2010

(30) Foreign Application Priority Data
May 18, 2009 (JP) 2009-120229
Oct. 21, 2009 (JP) 2009-242511

(51) Int. Cl. B41J 2/165

(52) U.S. Cl. 347/30

(57) ABSTRACT

A method is used to maintain a fluid ejecting apparatus having a fluid ejection head that ejects fluid onto a medium. A rotary body has a fluid reception member that receives the fluid and a medium support member that supports the medium and is rotatable around a shaft extending in a direction perpendicular to an ejecting direction of the fluid. A rotation driving device drives and rotates the rotary body and moves the fluid reception member from a fluid reception position where the fluid reception member faces the fluid ejection head to a fluid non-reception position where the fluid reception is retracted from the fluid reception position. A suction device sucks the fluid in the fluid reception member. The method for maintaining the fluid ejecting apparatus includes synchronizing a driving operation of the rotation driving device with a driving operation of the suction device.

### BACKGROUND

1. Technical Field

The present invention relates to a method for maintaining a fluid ejecting apparatus and a fluid ejecting apparatus.

2. Related Art

As a fluid ejecting apparatus, an ink ejection recorder is, for example, well known. An ink ejection recorder is a device adapted to record a character or an image on a recording medium (a medium) and is configured to selectively eject ink (fluid) onto the recording medium from a nozzle mounted in a recording head (a fluid ejection head).

In the fluid ejecting apparatus, a maintenance operation for the recording head is periodically carried out in order to maintain the recording head in a good ejecting state or restore it to a good ejecting state. As a specific maintenance operation, it is possible to cite a process in which a cap member (a fluid reception member) is made to face the recording head and ink is flushed (ejected) from a nozzle so that a meniscus of the nozzle is controlled.

JP-T-2003-534165 discloses a structure of the related art in which a rotary body is provided below a fluid ejection head, and a recording-medium-supporting section and a cap member are attached to the rotary body. In accordance with the above structure, by rotating the rotary body, the recording-medium-supporting section or the cap member can be made to face the fluid ejection head so that a recording operation and a maintenance operation can be switchably carried out while the position of the fluid ejection head is fixed.

However, a problem arises that when the rotary body is rotated and the cap member is retracted so as to cause the fluid ejection head to face the support section from a state in which the fluid ejection head faces the cap member, ink reserved in the cap member may leak from its edge and flow through an outer peripheral portion of the rotary body so that another structural component or a recording medium may be contaminated.

### SUMMARY

An advantage of some aspects of the invention is that it provides a method for maintaining a fluid ejecting apparatus capable of preventing leakage of fluid to an outer peripheral portion of a rotary body, and a fluid ejecting apparatus.

A method for maintaining a fluid ejecting apparatus according to a first aspect of the invention, is disclosed. The fluid ejecting apparatus has a fluid ejection head that ejects fluid onto a medium, a rotary body that is provided with a fluid reception member that receives the fluid and a medium support member that supports the medium, and is rotatable around a shaft extending in a direction perpendicular to an ejecting direction of the fluid, a rotation driving device that drives and rotates the rotary body and moves the fluid reception member from a fluid reception position where the fluid reception member faces the fluid ejection head to a fluid non-reception position where the fluid reception is retracted from the fluid reception position, and a suction device that sucks the fluid in the fluid reception member. The method includes (a) synchronizing a driving operation of the rotation driving device with a driving operation of the suction device.

In accordance with the above method, the maintenance operation is carried out in such a manner that fluid is ejected from the fluid ejection head in to the fluid reception member placed on the fluid reception position. When the fluid reception member is moved to the fluid non-reception position and the operation transits to the recording operation, the suction device is driven in synchronization with the driving operation of the rotation driving device so as to suck the fluid in the fluid reception member. By virtue of the suction, the fluid in the fluid reception member is reduced so that it is possible to prevent the fluid from dropping to an outer peripheral portion of the rotary body from the fluid reception member which is inclined by the rotation of the rotary body.

In the method for maintaining a fluid ejecting apparatus according to the first aspect of the invention, the rotation driving device is preferably driven in association with the driving operation of the suction device in the synchronizing. With the above method of the invention, the fluid in the fluid reception member is continuously sucked during the rotation of the rotary body. Accordingly, the fluid in the fluid reception member is gradually reduced while the fluid reception member is inclined. Since the fluid in the fluid reception member is continuously sucked by a sucking force of the suction device, it is possible to prevent the fluid from dropping during the rotation of the rotary body.

In the method for maintaining a fluid ejecting apparatus according to the first aspect of the invention, the rotation driving device is preferably driven after driving the suction device in the synchronizing. With this method, the suction driving operation is carried out before the rotation driving operation of the rotary body. Then, the rotation driving operation of the rotary body is carried out while continuing the suction driving operation. Accordingly, in addition to the above action, the rotary body can be rotated under a condition that the fluid in the fluid reception member has been reduced beforehand so that it is possible to surely prevent the fluid from dropping during the rotation of the rotary body.

In the method for maintaining a fluid ejecting apparatus according to the first aspect of the invention, the suction device and the rotation driving device are preferably concurrently driven in the synchronizing. With this method, since the suction driving operation and the rotation driving operation are concurrently carried out, it is possible to reduce a transition time period from the maintenance operation to the recording operation.

In the method for maintaining a fluid ejecting apparatus according to the first aspect of the invention, the fluid non-reception position is on a position where the fluid reception member faces vertically downward, and the suction device is preferably driven until the driving operation of the rotation driving device is completed in the synchronizing. With this method, the suction driving operation is carried out until the rotation driving operation is completed, thereby preventing the fluid from dropping during the rotation of the rotary body. When the rotation driving operation is completed, the fluid reception member is placed on the fluid non-reception position. However, in a case where the fluid reception member faces vertically downward at the fluid non-reception position, the fluid flows only vertically downward by its own weight so that the fluid does not flow through the outer peripheral portion of the rotary body.

In the method for maintaining a fluid ejecting apparatus according to the first aspect of the invention, the rotation driving device is preferably driven after completing the driving operation of the suction device in the synchronizing. With this method, after the fluid in the fluid reception member is sucked out, the rotary body is rotated. Accordingly, it is possible to surely prevent the fluid from dropping from the fluid reception member.

The method for maintaining a fluid ejecting apparatus according to the first aspect of the invention, further preferably includes (b) controlling an amount of suction performed by the suction device on the basis of an amount of fluid held by the fluid reception member that varies with the driving operation of the rotation driving device. With this method, when the fluid reception member is inclined by the rotation driving operation, the amount of the fluid that can be held by the fluid reception member (hereinafter, referred to as “hold amount of the fluid”), varies. Fluid having an amount exceeding the hold amount drops so that the peripheral portion of the rotary body is contaminated. The hold amount of the fluid is determined depending on a height of an edge of the fluid reception member, a specific gravity of the fluid or a surface tension thereof. The hold amount of the fluid is determined depending on a height of an edge of the fluid reception member, a specific gravity of the fluid or a surface tension thereof. When the fluid reception member has an absorption material such as a sponge or a non-woven cloth, the hold amount of the fluid is determined depending on a capillary force of the absorption material. In the invention, since the amount of suction (hereinafter referred to as “suction amount”) is controlled on the basis of the hold amount of the fluid, the suction amount is controlled to be an adequate amount by which the fluid does not drop from the fluid reception member. Accordingly, it is possible to prevent the fluid from dropping without excessively driving the suction device. And then, it is possible to improve the durability of the suction device.

The method for maintaining a fluid ejecting apparatus according to the first aspect of the invention, preferably further includes (c) measuring an amount of the fluid in the fluid reception member, and (d) secondarily controlling an amount of suction performed by the suction device (hereinafter referred to as “suction amount”) on the basis of a measurement result obtained in the measuring. With this method, since the suction amount is changed corresponding to the amount of the fluid in the fluid reception member, it is possible to eliminate a time period for waste driving of the suction device. Accordingly, it is possible to improve the durability of the suction device.

A fluid ejecting apparatus according to a second aspect of the invention, includes a fluid ejection head that ejects fluid onto a medium, a rotary body that is provided with a fluid reception member that receives the fluid and a medium support member that supports the medium at an outer peripheral portion thereof, and is rotatable around a shaft extending in a direction perpendicular to an ejecting direction of the fluid, a rotation driving device that drives and rotates the rotary body and moves the fluid reception member from a fluid reception position where the fluid reception member faces the fluid ejection head to a fluid non-reception position where the fluid reception is retracted from the fluid reception position, a suction device that sucks the fluid in the fluid reception member, and a synchronization device that synchronizes a driving operation of the rotation driving device with a driving operation of the suction device. The synchronization device includes a driving force transmission device that transmits a driving force of a rotation driving source of the rotation driving device to the suction device so as to drive the suction device.

In accordance with the above configuration, an identical driving source is used for the rotation driving device and the suction device so that the cost can be reduced and the preciseness in the synchronizing of both driving operations can be improved.

In the fluid ejecting apparatus according to the second aspect of the invention, the driving force transmission device preferably includes a drive gear that is engaged with and rotated by the rotation driving source, a first follower gear that is engaged with the drive gear and is followably rotated so as to be displaced between a driving force transmission position where a driving force is transmitted to the rotation driving device and a driving force non-transmission position where the first follower gear is retracted from the driving force transmission position, and a second follower gear that is engaged with the drive gear and is followably rotated so as to be displaced between a driving force transmission position where a driving force is transmitted to the suction driving device and a driving force non-transmission position where the second follower gear is retracted from the driving force transmission position.

In accordance with the above configuration, a timing of driving the rotation driving device can be controlled by the movement of the first follower gear that follows the drive gear. A timing of driving the suction device can be controlled by the movement of the second follower gear that follows the drive gear. Accordingly, the timings of driving of the rotation driving device and the suction device can be arbitrary controlled.

In the fluid ejecting apparatus according to the second aspect of the invention, the driving force transmission device preferably includes a coupling member that couples the first follower gear and the second follower gear with each other in such a manner that a relative distance between the first follower gear and the second follower gear in a circumferential direction of the drive gear is made to be constant. With this configuration, the movements of the first follower gear and the second follower gear can be physically synchronized with each other.

A fluid ejecting apparatus according to a third aspect of the invention, includes a fluid ejection head that ejects fluid onto a medium, a rotary body that is provided with a fluid reception member that receives the fluid and a medium support member that supports the medium at an outer peripheral portion thereof, and is rotatable around a shaft extending in a direction perpendicular to an ejecting direction of the fluid, a suction device that sucks the fluid in the fluid reception member, a drive gear that is coupled with a rotation driving source and is rotated so as to function as a sun gear, first and second follower gears functioning as planetary gears, a rotary body gear that transmits a driving force to the rotary body, a suction pump gear that transmits a driving force to the suction device, a first transmission gear train having one or more gears, and a second transmission gear train having one or more gears. When the drive gear is rotated in one direction, the first follower gear transmits a driving force to the rotary body gear and the second follower gear transmits a driving force to the suction pump gear via the second transmission gear train. When the drive gear is rotated in the other direction, the second follower gear does not transmit a driving force to the rotary body gear and the first follower gear transmits a driving force to the suction pump gear via the first transmission gear train. One of the number of gears of the first transmission gear train and the number of gears of the second transmission gear train is an odd number, and the other number is an even number.

In accordance with the above configuration, the suction device can be driven by the rotation of the drive gear in both directions, but the rotary body is rotated by the rotation of the drive gear in only one direction. Accordingly, the suction device can be driven while rotating the rotary body and can be driven without rotating the rotary body. Other features of the invention will become clear from the specification and the drawings which will be described in detail below.

### BRIEF DESCRIPTION OF THE DRAWINGS

The invention will be described with reference to the accompanying drawings, wherein like numbers reference like elements.

FIG. 1 is a schematic view showing a structure of an ink jet printer according to a first embodiment of the invention.

FIG. 2 is a schematic view showing a recording head viewed from an ejection surface side according to the first embodiment of the invention.

FIG. 3 is a cross sectional view showing a structure of the recording head according to the first embodiment of the invention.

FIG. 4 is a schematic view showing a structure of a maintenance mechanism according to the first embodiment of the invention.

FIG. 5 is a schematic view showing a structure of the maintenance mechanism according to the first embodiment of the invention.

FIG. 6 is a schematic view showing a structure of a suction pump according to the first embodiment of the invention.

FIG. 7 is a schematic view showing a structure of a synchronization device according to the first embodiment of the invention.

FIG. 8 is a schematic view showing a state of the maintenance mechanism in an ink suction operation according to the first embodiment of the invention.

FIG. 9 is an explanatory view showing an action of the synchronization device in the ink suction operation according to the first embodiment of the invention.

FIG. 10 is an explanatory view showing an action of the synchronization device during a time period of transition to a recording operation according to the first embodiment of the invention.

FIGS. 11A and 11B are explanatory views showing an action of the maintenance mechanism during a time period of transition to a recording operation according to the first embodiment of the invention.

FIG. 12 is a schematic view showing a structure of the maintenance mechanism according to the first embodiment of the invention.

FIG. 13 is a schematic view showing of a structure of a synchronization device according to a second embodiment of the invention.

FIGS. 14A and 14B are explanatory views showing an action of the synchronization device during a time period of transition to a recording operation according to the second embodiment of the invention.

FIGS. 15A, 15B and 15C are explanatory views showing an action of the maintenance mechanism during a time period of transition to a recording operation according to the second embodiment of the invention.

FIG. 16 is a schematic view showing a structure of a synchronization device according to a third embodiment of the invention.

FIGS. 17A and 17B are explanatory views showing an action of the synchronization device during a time period of transition to a recording operation according to the third embodiment of the invention.

FIGS. 18A and 18B are explanatory views showing an action of a maintenance mechanism during a time period of transition to a recording operation according to the third embodiment of the invention.

FIG. 19 is a schematic view showing a structure of an ink jet printer according to a fourth embodiment of the invention.

### DESCRIPTION OF EXEMPLARY EMBODIMENTS

Various embodiments of a method for maintaining a fluid ejecting apparatus and a fluid ejecting apparatus according to the invention will be explained with reference to the appended drawings. Note that, scales of members or components in the drawings are varied as appropriate from actual scales so that they can be readily recognized. In each of the embodiments, an ink jet printer (hereinafter referred to as an ink jet printer) is exemplarily shown as the fluid ejecting apparatus according to the embodiment of the invention.

### First Embodiment

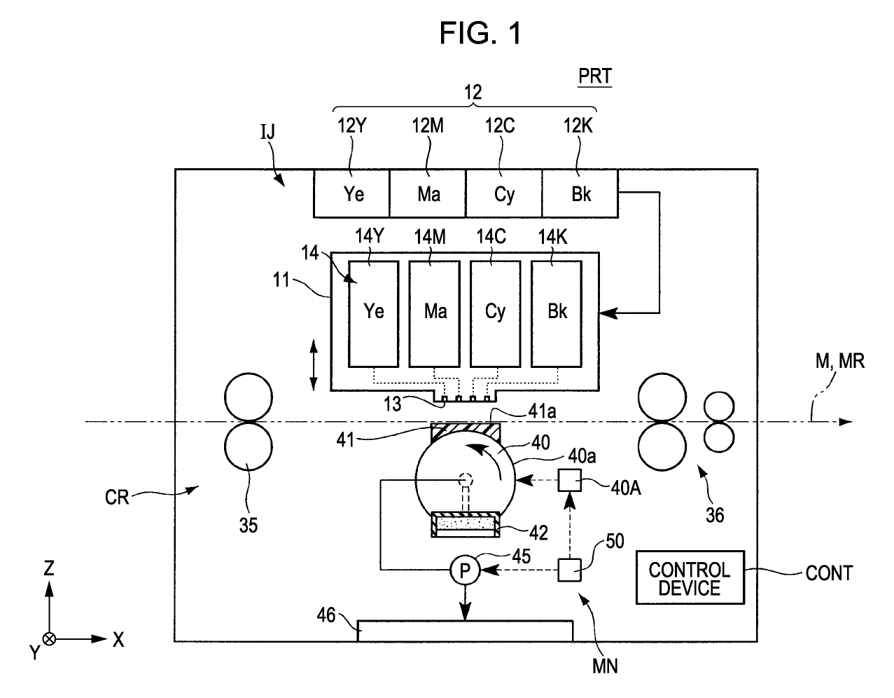

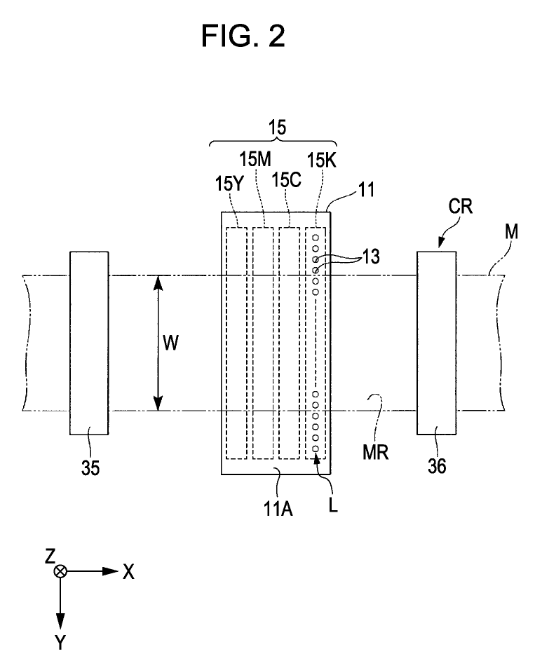

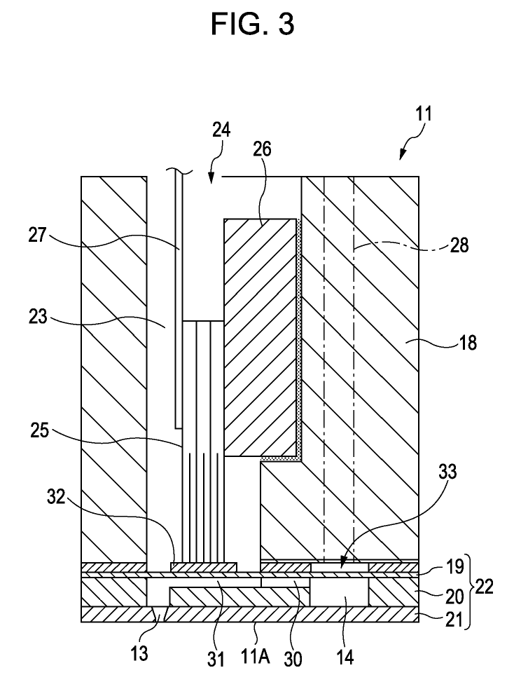

FIG. 1 is a schematic view showing a structure of an ink jet printer PRT according to a first embodiment in the invention. FIG. 2 is a schematic view showing a recording head 11 viewed from an ejection surface 11A side according to the first embodiment in the invention. FIG. 3 is a cross sectional view showing a structure of the recording head 11 according to the first embodiment of the invention. Note that an XYZ orthogonal coordinate system is set as in the drawings and a positional relationship among components or members may be described while referring to the XYZ orthogonal coordinate system. In the above case, a direction X represents a transporting direction of a recording medium M, a direction Y represents a transporting face width direction perpendicular to the transporting direction, and a direction Z represents a height direction (a vertical direction) which is perpendicular to the direction X and the direction Y.

The ink jet printer PRT is configured to perform a recording operation for printing predetermined information or images on a recording medium (medium) M by ejecting ink droplets (fluid). A recording paper sheet, a plastic material or a glass substrate is, for example, used as the recording medium M. As shown in FIG. 1, the ink jet printer PRT is provided with an ink ejecting mechanism IJ having the recording head (a fluid ejection head) 11 that ejects ink, a transporting mechanism CR that transports the recording medium M, a maintenance mechanism MN that maintains the recording head 11, and a control device CONT having a computer system that integrally controls operations of the above mechanisms.

The ink ejecting mechanism IJ includes the recording head 11 that ejects ink droplets (fluid) and an ink supply section 12 that supplies ink to the recording head 11. The ink used in the embodiment is a liquid medium having as basic components a dye or pigment and a solvent for dissolving or dispersing the dye or pigment, and various additives added to the above if needed.

The recording head 11 has common ink chambers 14 (14Y, 14M, 14C and 14B) corresponding to colors of yellow (Ye), magenta (Ma), cyan (Cy) and black (Bk), and is configured to eject inks corresponding to the colors from nozzles 13 respectively communicating with the ink chambers 14. The recording head 11 is movable in the direction Z by means of a head moving device (not shown). The ink supply section 12 has ink tanks 12 (12Y, 12M, 12C and 12K) that respectively store the above described four-color inks. In addition, the ink supply section 12 has an ink supply pump (not shown) that supplies inks to the common ink chambers 14 from the ink tanks 12Y, 12M, 12C and 12K, the inks corresponding to the colors of the ink chambers 14.

As shown in FIG. 2, the recording head 11 is a line-type recording head having a nozzle forming region 15 provided over a width (a maximum recording medium width W) of a recording medium M having a maximum size, the recording medium M being a printing target of the ink jet printer PRT. The nozzle forming region 15 has nozzle forming regions 15Y, 15M, 15C and 15K corresponding to the colors of inks. The nozzles 13 are arranged in two or more rows in the direction Y (the width direction of the recording medium M) corresponding to the respective nozzle forming regions 15 so as to form nozzle rows L. The ejection surface 11A having the plurality of nozzles 13 arranged thereon is disposed to face in a direction opposite to the direction Z (vertically downward in FIG. 1).

As shown in FIG. 3, the recording head 11 has a head body 18 and a fluid channel forming unit 22 connected to the head body 18. The fluid channel forming unit 22 is provided with a diaphragm plate 19, a fluid channel substrate 20 and a nozzle substrate 21. The fluid channel forming unit 22 is also provided with formed thereon the common ink chamber 14, an ink supply hole 30 and a pressure chamber 31. In addition, the fluid channel forming unit 22 is further provided with an island portion 32 that functions as a diaphragm portion and a compliance portion 33 adapted to absorb fluctuations of pressure in the common ink chamber 14. An accommodating space 23 adapted to accommodate a fixing member 26 and a drive unit 24, and an inner fluid channel 28 adapted to guide ink to the fluid channel forming unit 22 are formed on the head body 18.

In the recording head 11 having the above structure, when a drive signal is input to the drive unit 24 via a cable 27, a piezoelectric element 25 is expanded or contracted. The diaphragm plate 19 is deformed (moved) therewith in a direction of approaching or separating from a cavity. Accordingly, the volume of the pressure chamber 31 varies so that the pressure in the pressure chamber 31 accommodating ink varies. By the variation of the pressure, ink is ejected from the nozzle 13. Meanwhile, the number of times that ejection of ink is performed is counted by the control device CONT so that an ejection amount of ink is measured on the basis of the counted number.

Returning to FIG. 1, the transporting mechanism CR is provided with a paper feed roller 35 and a discharge roller 36. The paper feed roller 35 and the discharge roller 36 are driven and rotated by a motor mechanism (not shown). The transporting mechanism CR is configured to transport the recording medium M along a transporting face MR in association with an ejecting operation of ink droplets by the ink ejection mechanism IJ.

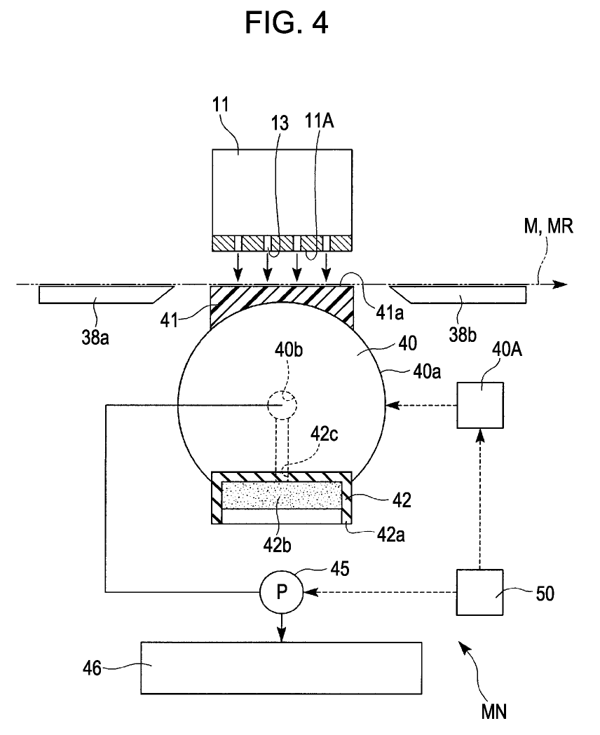

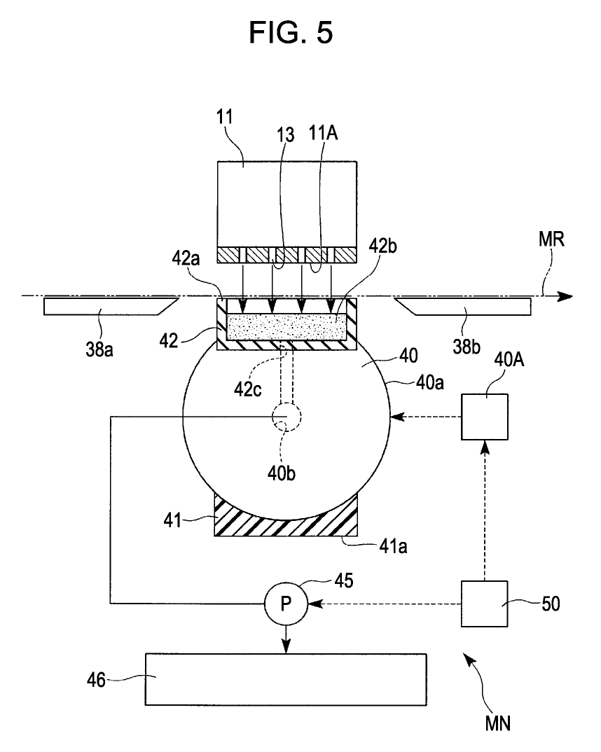

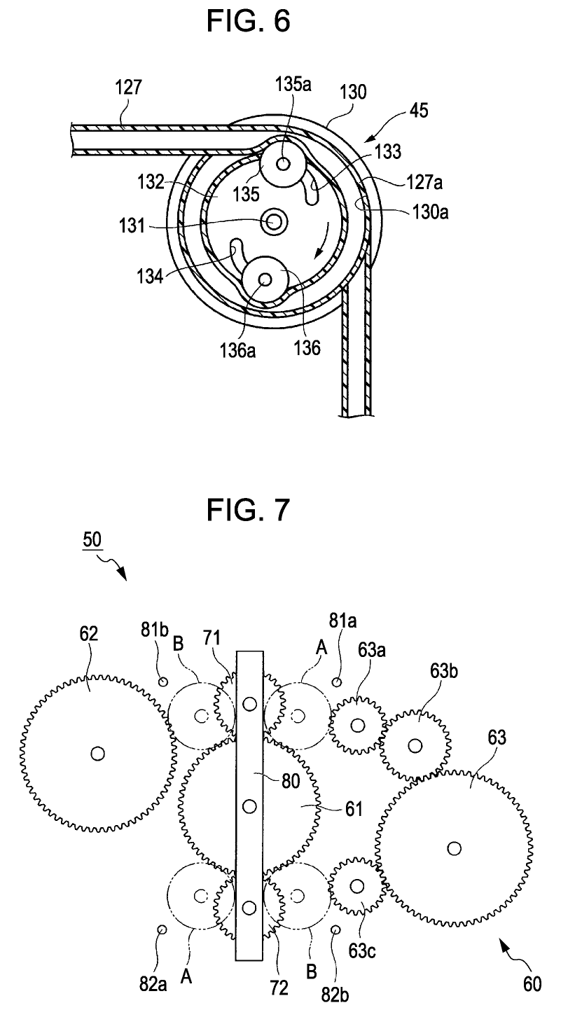

Next, a structure of the maintenance mechanism MN is described below with reference to FIGS. 4 to 8. FIGS. 4 and 5 are schematic views showing the structure of the maintenance mechanism MN according to the first embodiment of the invention. FIG. 4 shows a state of the maintenance mechanism MN during a recording operation and FIG. 5 shows a state of the maintenance mechanism MN during a flushing operation. FIG. 6 is a schematic view showing a structure of the suction pump 45 according to the first embodiment of the invention. FIG. 7 is a schematic view showing a structure of a synchronization device 50 according to the first embodiment of the invention.

As shown in FIG. 4, the maintenance mechanism MN includes a rotary body 40 that is driven and rotated by a rotation driving device 40A, a platen member (a medium support member) 41 and a cap member (a fluid reception member) 42 that are provided on an outer peripheral portion 40a of the rotary body 40, the suction pump (a suction device) 45 that sucks ink in the cap member 42, a waste ink tank 46 that stores the ink sucked by the suction pump 45, and the synchronization device 50 that synchronizes a driving operation of the rotation driving device 40A with a driving operation of the suction pump 45.

The rotary body 40 is provided at a position facing the ejection surface 11A of the recording head 11 and is supported so as to be rotatable around a shaft extending in the direction Y perpendicular to an ejecting direction of ink. The rotary body 40 is driven and rotated around the shaft by the rotation driving device 40A. In addition, the rotary body 40 is provided with an encoder for detecting a rotational angle of the rotary body 40 and the detection result is output to the control device CONT.

The platen member 41 is a medium-supporting section that supports the recording medium M at a position facing the recording head 11. The platen member 41 has a support face 41a for supporting the recording medium M. The support face 41a constitutes a part of the transporting face MR together with a platen 38a and a platen 38b (see FIG. 4). The support face 41a of the platen member 41 is formed so as to cover a region corresponding to the nozzle forming region 15 of the recording head 11.

The cap member 42 is a tray-shaped member for capping the ejection surface 11A of the recording head 11. A lip portion 42a constituting an opening edge portion of the cap member 42 is formed of an elastic material such as a rubber material and can be brought into contact with the ejection surface 11A so as to cover the plurality of nozzles 13. Meanwhile, the cap member 42 is also a part for receiving ink which is ejected during performing of a flushing operation for ejecting ink whose viscosity has increased in the nozzle 13 (see FIG. 5). The cap member 42 has an ink absorption member 42b in a tray. A fluid outlet 42c communicating with an ink discharge hole 40b formed in the rotary body 40 is provided in a central part of the bottom of the cap member 42.

The cap member 42 is provided on the rotary body 40 at the side opposite the platen member 41. Accordingly, the platen member 41 and the cap member 42 are placed on the rotary body 40 at respective positions shifted from each other by 180 degrees in the rotational direction. Since the cap member 42 and the platen member 41 are respectively placed at the separated positions, ink is not liable to reach the platen member 41 even when the ink overflows from the cap member 42.

The suction pump 45 is provided between the ink discharge hole 40b and the waste ink tank 46 and is configured to perform a suction operation through the fluid outlet 42c of the cap member 42. The waste ink tank 46 stores the ink flowing thereinto due to the suction operation. Meanwhile, the waste ink tank 46 is configured to be detachably attached to a device body of the ink jet printer PRT and the ink stored in the waste ink tank 46 may be periodically thrown away.

In the embodiment, as shown in FIG. 6, a tube pump type suction pump 45 is used. The suction pump 45 has a cylindrical case 130. A circular pump wheel 132 is accommodated in the case 130 so as to be rotatable around a wheel shaft 131. An intermediate part 127a of a discharge tube 127 communicating with the ink discharge hole 40b is accommodated in the case 130 so as to be disposed along an inner peripheral wall 130a of the case 130.

A pair of roller guide grooves 133 and 134 each having an outwardly convex arch shape are formed at positions opposing to each other with the wheel shaft 131 therebetween. Each of the roller guide grooves 133 and 134 is constituted in such a manner that one end is positioned at an outer peripheral side of the pump wheel 132 and the other end is positioned at an inner side of the pump wheel 132. Namely, each of the roller guide grooves 133 and 134 extends in such a manner that the more a position in the groove is advanced toward the other end from the one end, the more the position is away from the outer peripheral portion of the pump wheel 132. A pair of rollers 135 and 136 as pressing members are inserted into the respective roller guide grooves 133 and 134 and supported thereby via respective rotational shafts 135a and 136a. Meanwhile, the rotational shafts 135a and 136a can be slidably moved in the respective roller guide grooves 133 and 134.

Here, an operation of the suction pump 45 is described below. In a case where the pump wheel 132 is rotated in a forward direction (the direction of an arrow), the rollers 135 and 136 move toward the respective one ends of the roller guide grooves 133 and 134 (at the outer peripheral side of the pump wheel 132) and rotate while sequentially pressing the intermediate part 127a of the discharge tube 127 toward a waste ink tank 46 side from a cap member 42 side. As a result of the rotation, the inside of the discharge tube 127 at the upstream side from the suction pump 45 (at a cap member 42 side) is made to have a negative pressure. As a result, ink reserved in the cap member 42 is transported to the waste ink tank 46.

In addition, in a case where the pump wheel 132 is rotated in a backward direction (an opposite direction of the direction of the arrow), each of the rollers 135 and 136 moves to the other end (the inner peripheral side of the pump wheel 132) of the respective roller guide grooves 133 and 134. The movement causes each of the rollers 135 and 136 to be under a condition that each of the rollers 135 and 136 does not crush the intermediate part 127a of the discharge tube 127 so that the inner part of the discharge tube 127 is not in a negative pressure state and the discharge tube 127 does not function as a pump.

As shown in FIG. 7, the synchronization device 50 has a driving force transmission device 60 that transmits a driving force of a motor (a rotation driving source) 51 of the rotation driving device 40A to the suction pump 45 so as to drive the suction pump 45. Namely, the rotary body 40 and the suction pump 45 in the embodiment are driven by the identical rotation driving source.

The driving force transmission device 60 has a drive gear 61 coupled to an output shaft of the motor 51, a rotary body gear 62 coupled to a rotational shaft of the rotary body 40 and a suction pump gear 63 coupled to the wheel shaft 131 of the suction pump 45. The driving force transmission device 60 further has a first follower gear 71 and a second follower gear 72 that are engaged with the drive gear 61 and are followably rotated, and a lever 80 that is supported by a rotational shaft of the drive gear 61 so as to be rotatable around the shaft. The first follower gear 71 is rotatably supported by one end of the lever 80 and the second follower gear 72 is rotatably supported by the other end of thereof. Accordingly, the first follower gear 71 and the second follower gear 72 maintain a relative positional relationship that they are shifted with each other by 180 degrees in the circumferential direction (a pitch direction) of the drive gear 61 so as to be moved under a physically synchronized condition. With this configuration, the drive gear 61 operates as a sun gear and the first and second gears 71 and 72 operate as planetary gears. Note that it is not shown in the drawing but the first and second gears 71 and 72 are provided with an urging member for causing them to function as the planetary gears. The driving force transmission device 60 is equipped with position restricting members 81a, 81b, 82a and 82b that restrict a movable range of the lever 80 and an engagement depth of the gears.

In addition, the driving force transmission device 60 has a first transmission gear train including two first transmission gears 63a and 63b provided between the first follower gears 71 and the suction pump gear 63, and a second transmission gear train including a second transmission gear 63c provided between the second follower gear 72 and the suction pump gear 63. Namely, there are a case that a driving force of the drive gear 61 is transmitted to the suction pump gear 63 from the first follower gear 71 via the transmission gears 63a and 63b and a case that the driving force is transmitted to the suction pump gear 63 from the second follower gear 72 via the second transmission gear 63c. On the other hand, a driving force is transmitted to the rotary body gear 62 via the first follower gear 71.

The synchronization device 50 having the driving force transmission device 60 displaces the first follower gear 71 and the second follower gear 72 between an ink suction operation position (a position indicated by symbol A in FIG. 7) and a recording operation transition position (a position indicated by symbol B in FIG. 7: a driving force transmission position) depending on the rotating direction of the drive gear 61 so as to perform a desired operation. On the ink suction operation position, the driving force is transmitted to only the suction pump gear 63. On the recording operation transition position, the driving force is concurrently transmitted to the rotary body gear 62 and the suction pump gear 63. At a position between the positions respectively indicated by symbols A and B in FIG. 7, there is a driving force non-transmission position (a position indicated by a solid line in FIG. 7) where the driving force is not transmitted to both the rotary body gear 62 and the suction pump gear 63.

The ink jet printer PRT having the above structure periodically performs a maintenance operation for the recording head 11 by driving the maintenance mechanism MN in order to maintain the recording head 11 to be in a good ejecting state or restore it to a good ejecting state. As the maintenance operation by the maintenance mechanism MN, a flushing operation for performing preliminary ejection while driving the recording head 11 so as to remove ink having an increased viscosity and an ink suction operation for sucking the inside of the cap member 42 by means of the suction pump 45 so as to forcedly discharge ink from the nozzles 13 can be given. In the embodiment, the ink suction operation is exemplarily used as the maintenance operation and the action of the maintenance mechanism MN is described below. Note that a position where the cap member 42 is retracted from a fluid reception position in the maintenance mechanism MN as shown in FIG. 4 is referred to as “a fluid non-reception position”. On the other hand, a position where the cap member 42 faces the recording head 11 and receives ink as shown in FIG. 5 is referred to as “the fluid reception position”.

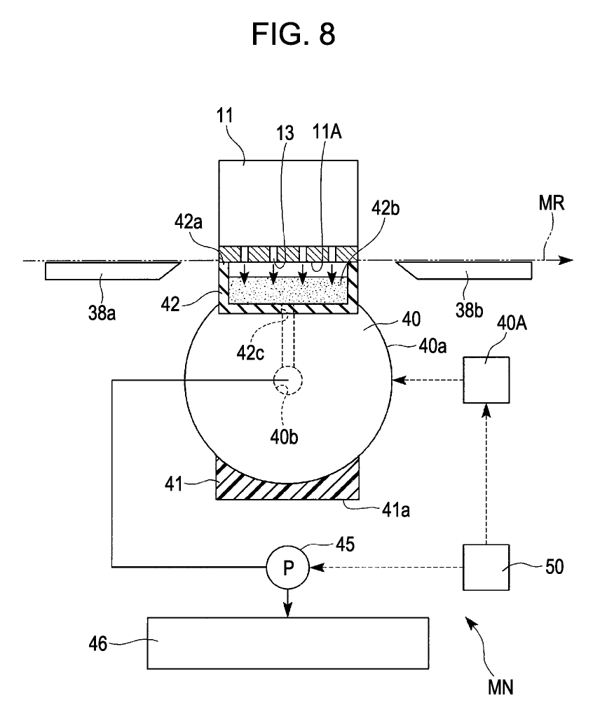

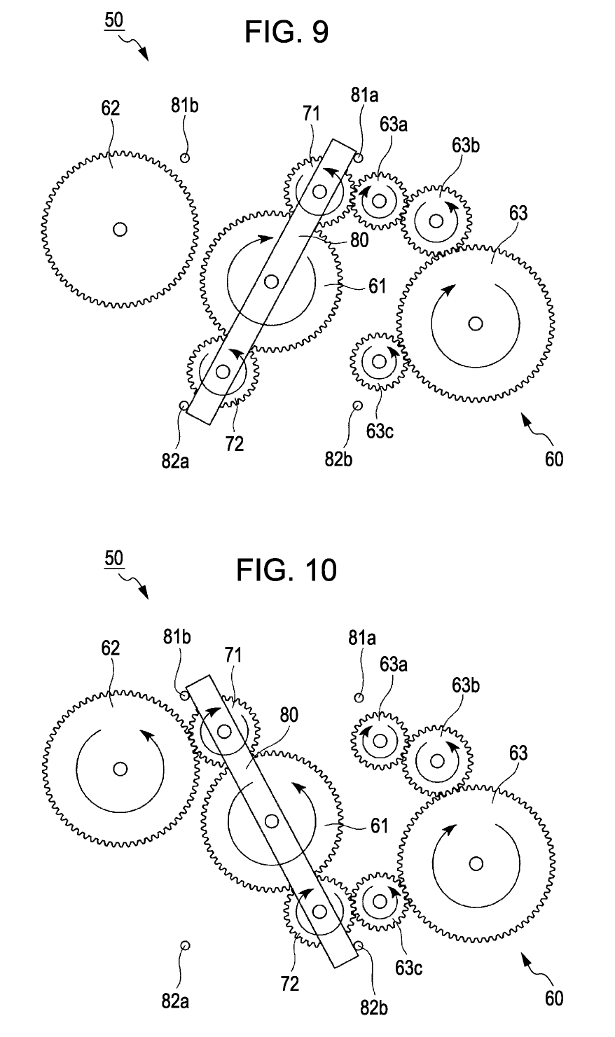

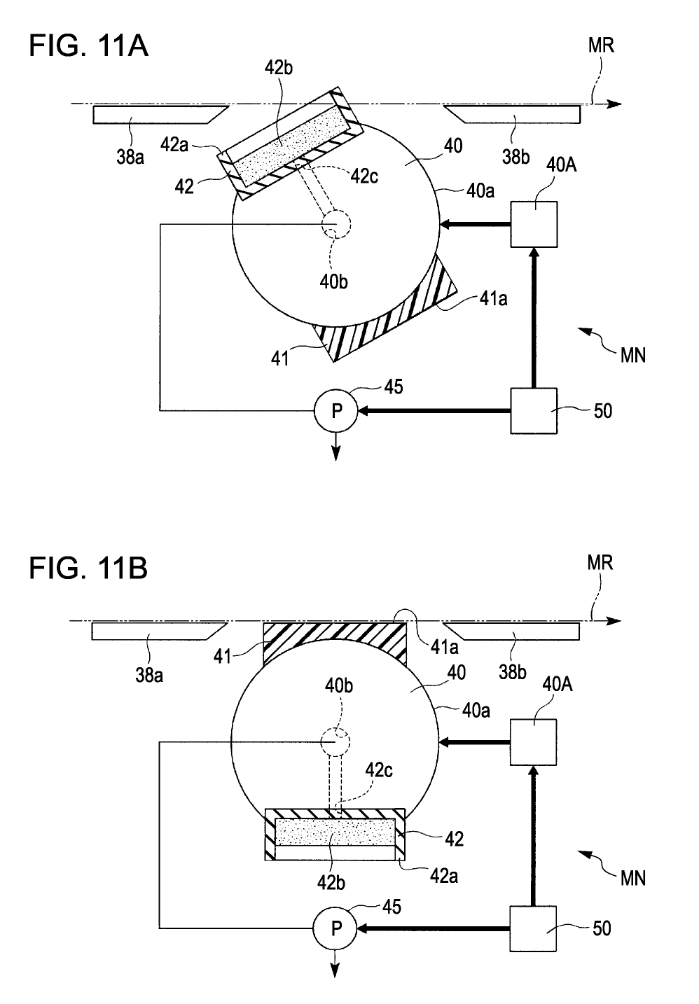

FIG. 8 is a schematic view showing a state of the maintenance mechanism MN in an ink suction operation in the embodiment. FIG. 9 is an explanatory view showing an action of the synchronization device 50 in the ink suction operation in the embodiment. FIG. 10 is an explanatory view showing an action of the synchronization device 50 during a time period of transition to a recording operation in the embodiment. FIGS. 11A and 11B are explanatory views showing an action of the maintenance mechanism MN during a time period of transition to the recording operation in the embodiment.

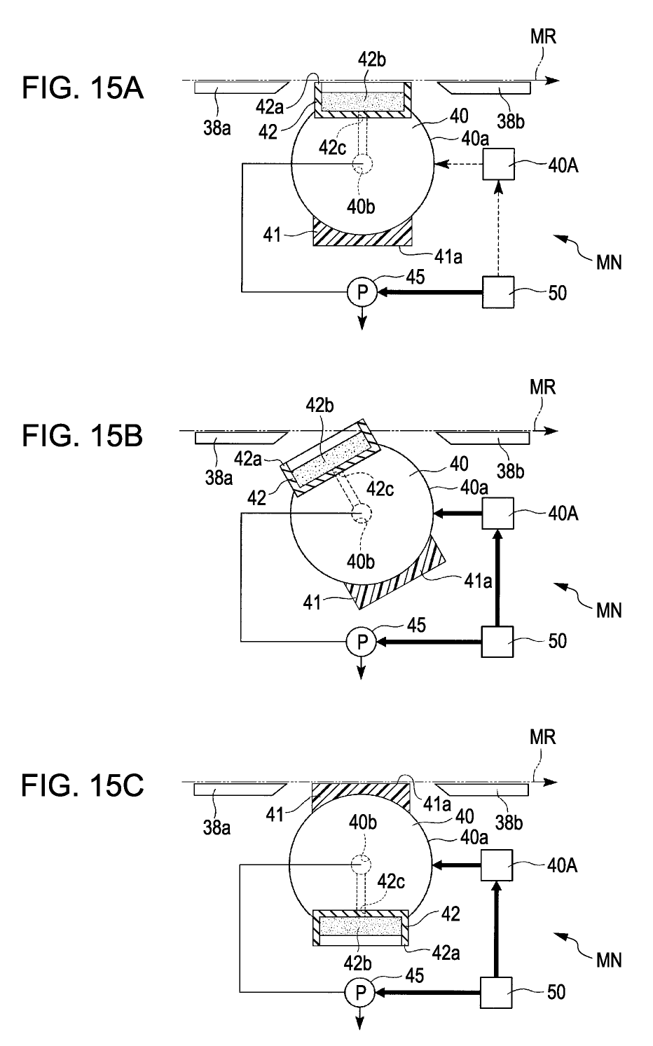

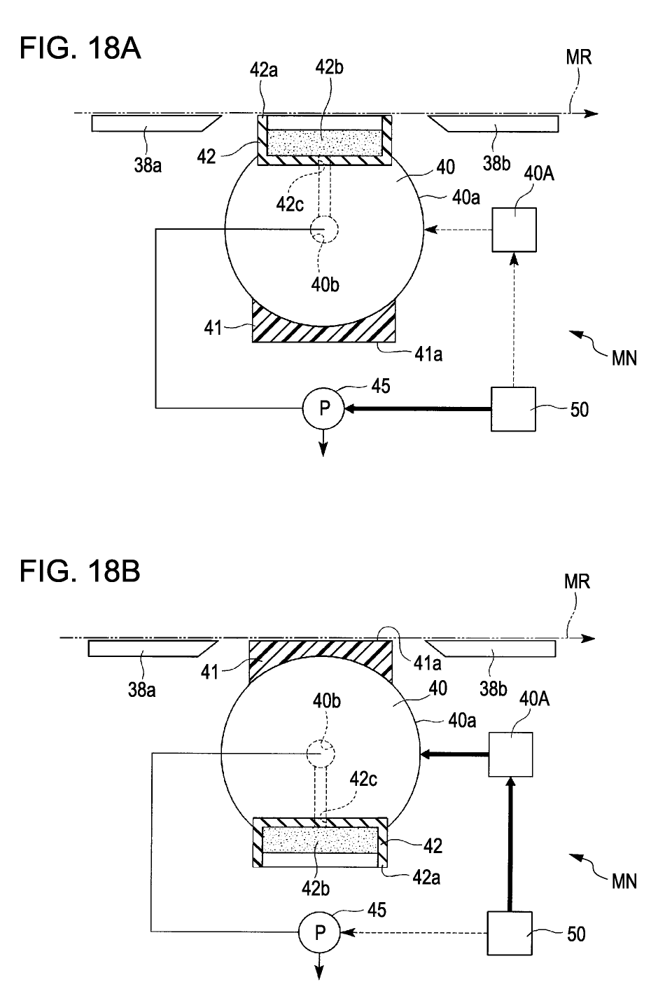

Meanwhile, in FIGS. 11A and 11B, arrows with thick lines from the synchronization device 50 to the rotary body 40 via the rotation driving device 40A indicate a state of “rotation driving” in which the rotary body 40 is driven and the cap member 42 is moved from the fluid reception position to the fluid non-reception position. On the other hand, an arrow with a thin line from the synchronization device 50 to the suction pump 45 indicates a state of “suction driving” in which the rotary body 40 is driven and ink in the cap member 42 is sucked. States described with reference to drawings (FIGS. 15A, 15B, 15C, 18A and 18B) in other embodiments are similar to the above. In a case where an arrow with a dotted line is added to a state instead of the arrow with the thick line indicates a driving stop state.

In the ink suction operation shown in FIG. 8, first, the recording head 11 is moved in a direction opposite to the direction Z and the ejection surface 11A is brought into intimate contact with the lip portion 42a so as to form an airtight chamber between the recording head 11 and the cap member 42. After that, the synchronization device 50 rotates the drive gear 61 in the clockwise direction and moves the first follower gear 71 to the ink suction operation position so as to cause the first follower gear 71 to be engaged with the first transmission gear 63a as shown in FIG. 9. Further, when the drive gear 61 is rotated in the clockwise direction, the driving force is transmitted to the suction pump gear 63 via the first follower gear 71 and first transmission gears 63a and 63b so that the suction pump gear 63 is followably rotated in the clockwise direction.

At that time, since the lever 80 is engaged with the position restricting member 81a or 82a and is not rotated anymore, the second follower gear 72 is not engaged with the rotary body gear 62. Since the rotary body gear 62 is not rotated, the rotary body 40 is not rotated so that the airtight chamber formed between the recording head 11 and the cap member 42 is maintained. In addition, when the suction pump gear 63 is rotated in the clockwise direction, the pump wheel 132 is rotated in the forward direction and the suction pump 45 is driven so as to suck the ink in the cap 42 and to make the airtight chamber to be in a negative pressure state. Accordingly, ink having an increased viscosity or adhering dust is sucked from the nozzles 13 so as to control meniscuses, thereby the ejection characteristic of the recording head 11 is recovered. After that, the recording head 11 is separated from the cap member 42. Next, as shown in FIG. 9, the synchronization device 50 rotates the drive gear 61 in the clockwise direction and rotates the suction pump gear 63 in the clockwise direction so as to perform the suction driving operation. By the above suction driving operation, ink is not sucked from the recording head 11, but the ink in the cap member 42 is discharged to the ink discharge hole 40b via the fluid outlet 42c.

During a time period of transition to the recording operation in the embodiment, as shown in FIGS. 10, 11A and 11B, “the rotation driving operation” in which the rotary body 40 is driven so as to move the cap member 42 from the fluid reception position to the fluid non-reception position and “the suction driving operation” in which the suction pump 45 is driven so as to suck ink in the cap member 42 are synchronized with each other. Accordingly, the rotation driving operation and the suction driving operation are concurrently carried out, and the suction driving operation is continued during the rotation driving operation so that dropping of ink is prevented (a synchronization process).

To be specific, as shown in FIG. 10, the synchronization device 50 first rotates the drive gear 61 in the counterclockwise direction and rotates the first and second follower gears 71 and 72 in the counterclockwise direction so as to engage the first follower gear 71 with the rotary body gear 62 and to engage the second follower gear 72 with the second transmission gear 63c (the recording operation transition position). When the drive gear 61 is further rotated in the counterclockwise direction, the rotary body gear 62 engaged with the first follower gear 71 is followably rotated in the counterclockwise direction. At the same time, the suction pump gear 63 engaged with the second follower gear 72 via the second transmission gear 63c is followably rotated in the clockwise direction.

As shown in FIG. 11A, by the rotation of the rotary body gear 62, the rotary body 40 is driven and rotated so that the cap member 42 is moved toward the fluid non-reception position. At the same time, by the rotation of the suction pump gear 63, the suction pump 45 performs the suction operation so as to suck the ink in the cap member 42. As shown in FIG. 11B, the suction pump 45 continues the suction operation until the cap member 42 is moved to the fluid non-reception position.

Thus, in the embodiment, the rotary body 40 is driven and rotated in association with the suction operation of the suction pump 45, the ink in the cap member 42 is gradually reduced while the cap member 42 is inclined. In addition, since the ink in the cap member 42 is continuously sucked and held by the sucking force of the suction pump 45, dropping of ink can be prevented during the rotation driving operation. Further, by concurrently performing the suction driving operation and the rotation driving operation, it is possible to reduce a time period of transition from the maintenance operation to the recording operation as compared to the first embodiment.

When the drive gear 61 is rotated in one direction, the first follower gear 71 is engaged with the rotary body gear 62 and the second follower gear 72 is engaged with the suction pump gear 63 via the second transmission gear 63c. When the drive gear 61 is rotated in the other direction, the first follower gear 71 is not engaged with the rotary body gear 62, but the second follower gear 72 is engaged with the suction pump gear 63 via the first transmission gears 63a and 63b. Since the number of gears between the second follower gear 72 and the suction pump gear 63 and the number of gears between the first follower gear 71 and the suction pump gear 63 are different from each other by one, the suction gear 63 is rotated in the clockwise direction even when the drive gear 61 is rotated in the different directions. As a result, both the suction operation of the suction pump 45 in association with the rotation of the rotary body 40 and the suction operation of the suction pump 45 without rotation of the rotary body 40 can be carried out so that the rotary body 40 is not rotated while ink is sucked from the recording head 11. Meanwhile, the first transmission gear train is equipped with the two gears 63a and 63b, and the second transmission gear train is equipped with one gear 63c in the embodiment. However, when the number of gears of one gear train is made to be an odd number and the number of the other gear train is made to be an even number, the suction pump gear 63 is rotated in the same direction in the above different cases.

When the suction operation of the suction pump 45 is stopped, a case may happen where ink held by the suction force drops by its own weight. However, since as shown in FIG. 11B, the suction pump 45 performs the suction operation until the cap member 42 faces vertically downward on the fluid non-reception position, ink does not drop from the cap member 42 in the way of the rotation of the rotary body 40. When the cap member 42 faces vertically downward, ink flows only vertically downward by its own weight so that the ink does not flow through the outer peripheral portion 40a of the rotary body 40.

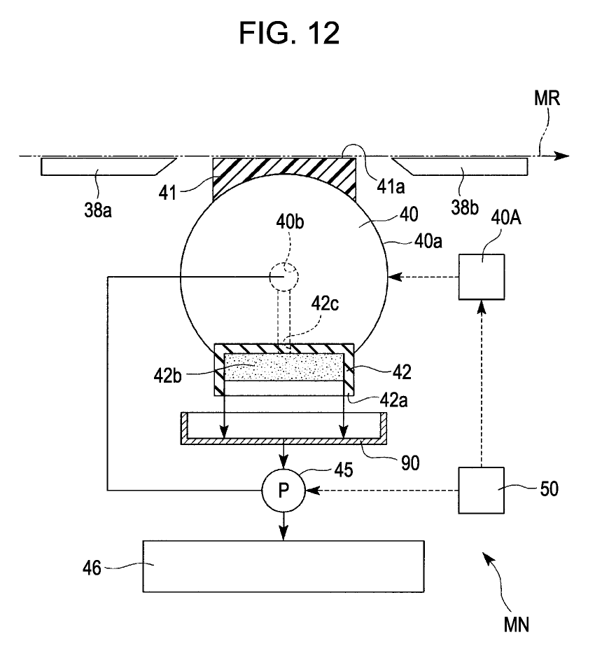

On the other hand, in a case where the dropping of ink is troublesome, a tray 90 can be provided below the cap member 42 as shown in FIG. 12 so as to cause the tray 90 to receive the ink that flows vertically downward by its own weight. Note that the ink received by the tray 90 can be sucked by the suction pump 45. In addition, instead of additional provision of the tray 90, the waste ink tank 46 can be used for receiving the ink.

### Second Embodiment

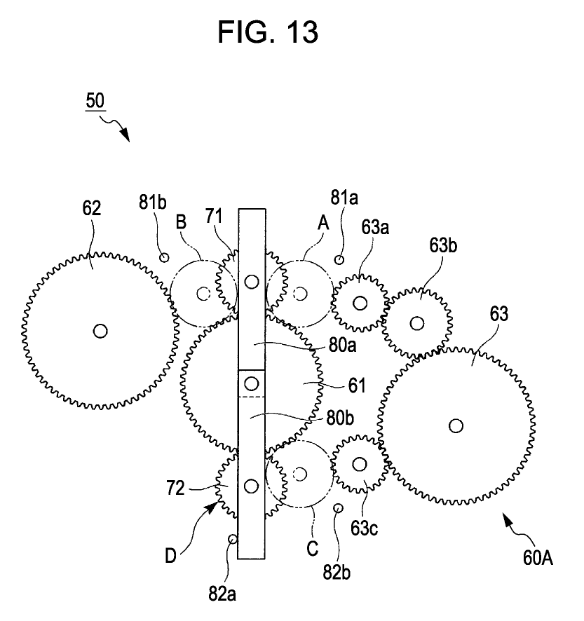

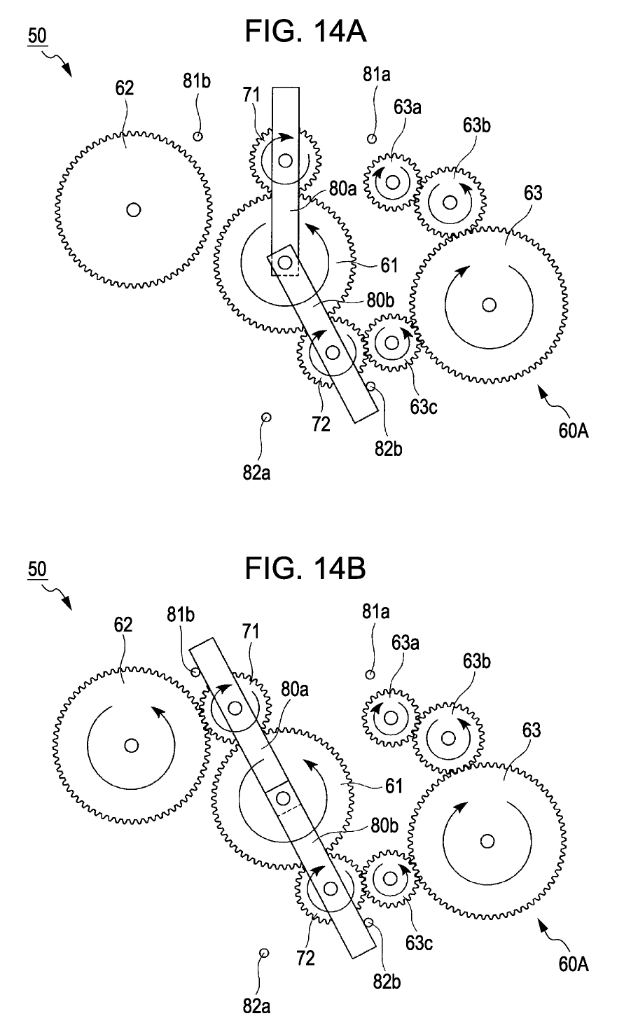

Next, a second embodiment is described below with reference to FIGS. 13 to 15C. Note that descriptions of components or members having the same structures as those in the above embodiment are omitted. FIG. 13 is a schematic view showing a structure of the synchronization device 50 according to the second embodiment of the invention. FIGS. 14A and 14B are explanatory views showing actions of the synchronization device 50 during a time period of transition to a recording operation according to the second embodiment of the invention. FIGS. 15A, 15B and 15C are explanatory views showing actions of the maintenance mechanism MN during a time period of transition to a recording operation according to the second embodiment of the invention.

As shown in FIG. 13, a structure of a driving force transmission device 60A in the second embodiment is different from that of the driving force transmission device 60 in the first embodiment and is constituted in such a manner that the first follower gear 71 and the second follower gear 72 are independently moved. The first follower gear 71 is rotatably supported by a lever 80a so as to be rotated around a rotation shaft of the drive gear 61. The second follower gear 72 is rotatably supported by a lever 80b so as to be rotated around the rotation shaft of the drive gear 61.

The synchronization device 50 having the driving force transmission device 60A displaces the first follower gear 71 between an ink suction operation position (a position indicated by symbol A in FIG. 13) and a recording operation transition position (a position indicated by symbol B in FIG. 13: a driving force transmission position) depending on the rotating direction of the drive gear 61 so as to perform a desired process. On the ink suction operation position, the driving force is transmitted to only the suction pump gear 63. On the recording operation transition position, the driving force is transmitted to only the rotary body gear 62. At a position between the positions respectively indicated by symbols A and B in FIG. 13, there is a driving force non-transmission position (a position indicated by a solid line in FIG. 13) where the driving force is not transmitted to both the rotary body gear 62 and the suction pump gear 63. In addition, the synchronization device 50 displaces the second follower gear 72 between an idling position (a position indicated by a solid line (symbol D) in FIG. 13) and a recording operation transition position (a position indicated by symbol C in FIG. 13: a driving force transmission position) depending on the rotating direction of the drive gear 61 so as to perform a desired process. On the idling position, the driving force is not transmitted to both the rotary body gear 62 and the suction pump gear 63 and the lever 80b is not rotated any more. On the recording operation transition position, the driving force is transmitted to only the suction pump gear 63.

Meanwhile, a movement distance of the first follower gear 71 between the position indicated by symbol A and the position indicated by symbol B in FIG. 13 is shorter than a movement distance of the second follower gear 72 between the position indicated by symbol C and the position indicated by symbol D. As a result, a time period where the first follower gear 61 is moved from the position indicated by symbol A to the position indicated by symbol B is shorter than a time period where the second follower gear 72 is moved from the position indicated by symbol D to the position indicated by symbol C. Namely, when the drive gear 61 is rotated in the counterclockwise direction, the driving force is transmitted to the suction pump gear 63 prior to the rotary body gear 62.

In the time period of transition to a recording operation in the second embodiment, as shown in FIGS. 14A to 15C, the rotation driving operation and the suction driving operation are synchronized with each other so that the rotation driving operation of the rotary body 40 is carried out after the suction driving operation of the suction pump 45 and the suction driving operation is continued during the rotation driving operation, thereby preventing ink from dropping (a synchronization process).

To be specific, after a flushing operation or an ink suction operation is carried out, the synchronization device 50 first rotates the drive gear 61 and moves the second follower gear 72 so as to engage the second follower gear 72 and the second transmission gear 63c with each other as shown in FIG. 14A. At that time, the first follower gear 71 is also moved in association with the rotation of the drive gear 61. However, since the movement distance of the first follower gear 71 is longer than that of the second follower gear 72, the first follower gear 71 is positioned on the driving force non-transmission position at a time point when the second follower gear 72 and the second transmission gear 63c are engaged with each other as shown in FIG. 14A. When the drive gear 61 is further rotated in the counterclockwise direction, the suction pump gear 63 is followably rotated in the clockwise direction by a driving force transmitted from the second follower gear 72 via the second transmission gear 63c. And then, the suction pump 45 performs the suction operation so as to suck the ink in the cap member 42 in association with the rotation of the suction pump gear 63 as shown in FIG. 15A.

After the above suction operation is started, the first follower gear 71 is continuously moved in association with the rotation of the drive gear 61. After a predetermined time period has elapsed from the starting of the suction operation (after a certain amount of ink is sucked by the suction operation), the first follower gear 71 and the rotary body gear 62 are engaged with each other. When the drive gear 61 is further rotated in the counterclockwise direction, the rotary body gear 62 engaged with the first follower gear 71 is followably rotated in the counterclockwise direction and the driving force is also transmitted to the rotary body 40 as shown in FIG. 15B. And then, the rotary body 40 is driven and rotated, and the cap member 42 is moved toward the fluid non-reception position. After that, the suction pump 45 continues the suction operation until the cap member 42 is moved to the fluid non-reception position as shown in FIG. 15C.

Thus, in the second embodiment, the rotary body 40 is driven and rotated in association with the suction operation of the suction pump 45, the ink in the cap member 42 is gradually reduced while the cap member 42 is inclined. In addition, since the ink in the cap member 42 is continuously sucked and held by the sucking force of the suction pump 45, dropping of the ink can be prevented during the rotation operation of the rotary body 40. Particularly, in the second embodiment, by using the difference between the movement distances of the first follower gear 71 and the second follower gear 72, the suction operation of the suction pump 45 is started prior to the rotation operation of the rotary body 40. Accordingly, in addition to the above action, the rotary body 40 can be rotated under a condition that an amount of ink in the cap member 42 has been reduced beforehand so that it is possible to surely prevent the ink from dropping during the rotating of the rotary body 40. Also in this embodiment, since the suction pump 45 continues the suction operation until the cap member 42 faces vertically downward at the fluid non-reception position, ink does not drop from the cap member 42 in the way of the rotation operation of the rotary body 40. When the cap member 42 faces vertically downward, ink flows only vertically downward by its own weight so that the ink does not flow through the outer peripheral portion 40a of the rotary body 40. Further, also in this embodiment as in the first embodiment, ink that drops at a time when the cap member 42 is placed on the fluid non-reception position can be received by using the tray 90 or the waste ink tank 46.

### Third Embodiment

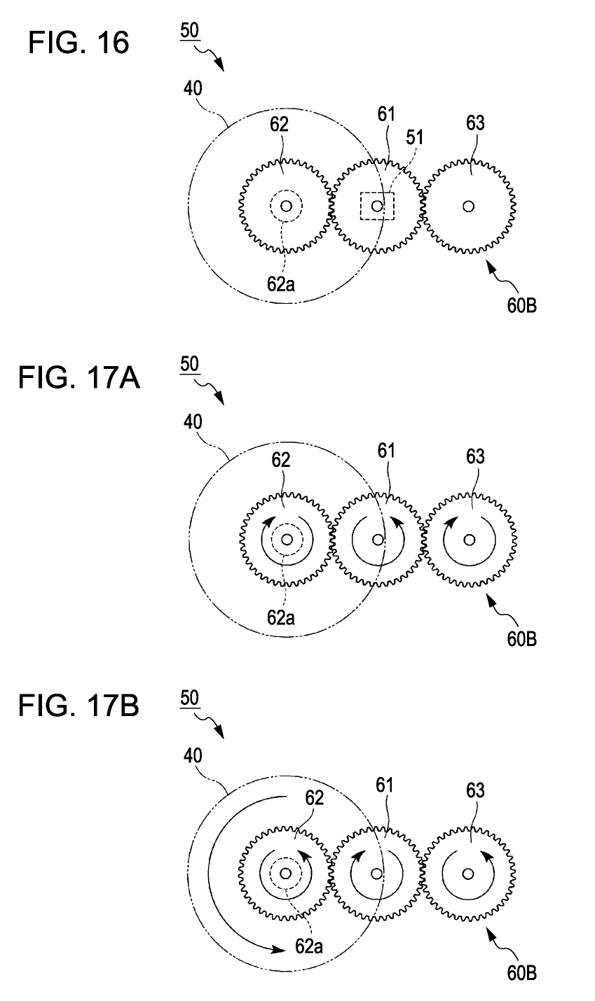

Next, a third embodiment of the invention is described below with reference to FIGS. 16 to 18B. Note that descriptions of components or members having the same structures as those in the above embodiments are omitted.

FIG. 16 is a schematic view showing a structure of a synchronization device according to the third embodiment of the invention. As shown in FIG. 16, the synchronization device 50 has a driving force transmission device 60B that transmits a driving force of the motor (the rotation driving source) 51 of the rotation driving device 40A so as to drive the suction pump 45. Namely, the rotary body 40 and the suction pump 45 in the embodiment are driven by the identical rotation driving source. The driving force transmission device 60B includes the drive gear 61 that is coupled to the output shaft of the motor 51, the rotary gear 62 that is coupled to the rotation shaft of the rotary body 40 and is engaged with the drive gear 61 so as to be followably rotated, and the suction pump gear 63 that is coupled to the wheel shaft 131 of the suction pump 45 and is engaged with the drive gear 61 so as to be followably rotated. The rotary body gear 62 in the embodiment is provided with a one-way clutch 62a so as to rotate the rotary body 40 in only one direction, i.e., the counterclockwise direction.

The inkjet printer PRT in the third embodiment drives the maintenance mechanism MN so as to periodically perform the maintenance operation of the recording head 11 in order to maintain the recording head 11 in a good ejecting state or restore it to a good ejecting state. As the maintenance operation, a flushing operation for removing ink having an increased viscosity by preliminarily performing ejection of the ink while driving the recording head 11 can be given.

In the flushing operation, the rotary body 40 is first driven so as to cause the cap member 42 and the recording head 11 to be opposed with each other in the direction Z under a condition that a recording medium M is not placed as shown in FIG. 5. After that, the recording head 11 is driven and ink having an increased viscosity is preliminarily ejected in to the cap member 42 facing the recording head 11 so as to control meniscuses, thereby recovering the ejection characteristic of the recording head 11. Note that the position where the cap member 42 faces the recording head 11 and receives the ink as shown in FIG. 5, is referred to as “the fluid reception position”. As shown in FIG. 4, after the flushing operation is completed, the rotary body 40 is rotated by 180 degrees so as to cause the platen member 41 and the recording head 11 to be opposed with each other in the direction Z, thereby transiting the ink jet printer PRT into a recording operation for ejecting ink onto a recording medium M. Note that a position where the cap member 42 is retracted from the fluid reception position as shown in FIG. 4 is referred to as “the fluid non-reception position”.

In the flushing operation, when the cap member 42 is moved from the fluid reception position to the fluid non-reception position under a condition that ink is reserved in the cap member 42, the reserved ink may drop from the cap member 42, thereby contaminating the outer peripheral portion 40a of the rotary body 40. The ink jet printer PRT in the embodiment, performs operations described below with reference to FIGS. 17A to 18B so as to prevent dropping of ink while the maintenance operation is transited to the recording operation (hereinafter, referred to as a time period of transition to the recording operation).

FIGS. 17A and 17B are explanatory views showing an action of the synchronization device 50 during a time period of transition to the recording operation according to the third embodiment of the invention. FIGS. 18A and 18B are explanatory views showing an action of the maintenance mechanism MN during a time period of transition to the recording operation according to the third embodiment of the invention. Note that FIG. 17A corresponds to FIG. 18A and FIG. 17B corresponds to FIG. 18B. In addition, in FIGS. 18A and 18B, arrows with thick lines from the synchronization device 50 to the rotary body 40 via the rotation driving device 40A indicate a state of “a rotation driving operation” in which the rotary body 40 is driven and the cap member 42 is moved from the fluid reception position to the fluid non-reception position. An arrow with a thin line from the synchronization device 50 to the suction pump 45 indicates a state of “a suction driving operation” in which the rotary body 40 is driven and the ink in the cap member 42 is sucked.

In the above process, the rotation driving operation and the suction driving operation are synchronized with each other so that dropping of ink is prevented (a synchronization process). As shown in FIG. 18A, the synchronization device 50 performs the suction driving operation of the suction pump 45 so as to suck the ink from the inside of the cap member 42 placed on the fluid reception position. As shown in FIG. 18B, when sucking of the ink is completed, the synchronization device 50 performs the rotation driving process of the rotary body 40 so as to move the cap member 42 from the fluid reception position to the fluid non-reception position so as to cause the maintenance operation to transit to the recording operation.

To be specific, the synchronization device 50 first rotates the drive gear 61 in the counterclockwise direction as shown in FIG. 17A. The suction pump gear 63 engaged with the drive gear 61 is followably rotated in the clockwise direction. When the pump wheel 132 is rotated in the forward direction in association with the rotation of the suction pump gear 63 as shown in FIG. 6, the suction driving operation for making the inside of the discharge tube 127 to be in a negative pressure state is carried out so that the ink reserved in the cap member 42 is transported to the waste ink tank 46 (see FIG. 18A). Meanwhile, the rotary body gear 62 engaged with the drive gear 61 is followably rotated in the clockwise direction. However, since the one-way clutch 62a is operated, the driving force is not transmitted to the rotary body 40.

In addition, since the number of times of ejection of ink ejected in to the cap member 42 in the flushing operation is counted by the control device CONT, an ejection amount of ink is measured on the basis of the counted value. The synchronization device 50 controls a suction amount of the ink sucked by the suction pump 45 (a measuring process, a second suction amount control process). Namely, only the amount of ink ejected in to the cap member 42 in the flushing operation is sucked. Thus, since the suction amount is changed in accordance with the amount of the ink in the cap member 42, it is possible to eliminate a time period for unnecessarily driving the suction pump 45. Consequently, the durability of the suction pump 45 can be improved. Note that the function of controlling the suction amount of ink can be applied to the first and second embodiments without any trouble.

When the ink is sucked out from the cap member 42 so as to make the cap member 42 empty by the suction driving operation, the synchronization device 50 rotates the drive gear 61 in the clockwise direction as shown in FIG. 17B. As a result, the rotary body gear 62 engaged with the drive gear 61 is followably rotated in the counterclockwise direction. In association with the rotation of the rotary body gear 62, the driving force is transmitted to the rotary body 40 without causing the one-way clutch to operate and the rotary body 40 is driven and rotated so as to move the cap member 42 to the fluid non-reception position (see FIG. 18B). Meanwhile, while the suction pump gear 63 engaged with the drive gear 61 is followably rotated in the counterclockwise direction, the pump wheel 132 is rotated in the direction opposite to the above, i.e., clockwise direction so that the suction operation is not carried out.

Thus, in the third embodiment, since the rotary body 40 is rotated after the ink in the cap member 42 is sucked out, it is possible to prevent the ink from dropping to the outer peripheral portion 40a from the cap member 42.

Therefore, in accordance with the above described third embodiment, the ink jet printer PRT includes the recording head 11 that ejects ink, the rotary body 40 that is provided with the cap member 42 adapted to receive ink at its outer peripheral portion 40a and is rotatable around the shaft extending in the direction perpendicular to the ejecting direction of ink, the rotation driving device 40A that drives and rotates the rotary body 40 and moves the cap member 42 from the fluid reception position where the cap member 42 faces the recording head 11 to the fluid non-reception position where the cap member 42 is retracted from the fluid reception position, and the suction pump 45 that sucks ink in the cap member 42. The ink jet printer PRT further includes the synchronization device 50 that is configured to synchronize the rotation driving operation of the rotation driving device 40A with the suction driving operation of the suction pump 45 so as to drive the rotation driving device 40A after completion of the driving operation of the suction pump 45.

In accordance with the above configuration, the flushing operation is carried out by ejecting ink from the recording head 11 in to the cap member 42 placed on the fluid reception position. During the time period of transition to the recording operation, the suction pump 45 is driven in synchronization with the driving of the rotation driving device 40A so as to suck the ink in the cap member 42. The ink in the cap member 42 is reduced by the suction operation so that it is possible to prevent ink from dropping to the outer peripheral portion 40a of the rotary body 40 from the cap member 42 that is inclined by the rotation.

### Fourth Embodiment

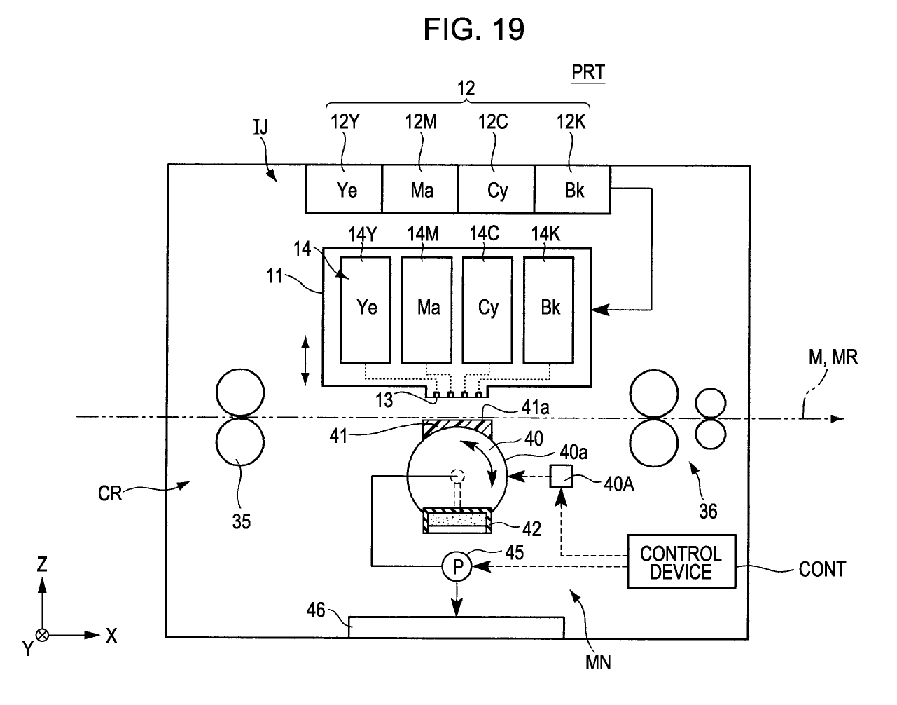

Next, a fourth embodiment of the invention is described below with reference to FIG. 19. Note that descriptions of components or members having the same structures as those in the above embodiments are omitted. FIG. 19 is a schematic view showing a structure of an ink jet printer PRT in according to the fourth embodiment of the invention.

In the fourth embodiment, the rotation driving device 40A that drives the rotary body 40 and the suction pump 45 respectively have independent rotation driving sources (motors). The synchronization between the rotation driving operation of the rotary body 40 and the suction driving operation of the suction pump 45 is carried out under the control of the control device CONT. That is, the synchronization device in the fourth embodiment is alternated by the control device CONT. In the fourth embodiment, since a timing of the rotation driving operation of the rotary body 40 and a timing of the suction driving operation of the suction pump 45 can be electrically controlled, the action of the maintenance mechanism MN during the time period of transition to the recording operation in the above first to third embodiments can be realized.

The suction amount of ink by the suction pump 45 is controlled independently from the driving of the rotary body 40 so that a method for controlling the suction amount during the time period of transition to the recording operation can be used as described below (a suction amount control process). Namely, in the invention, when the cap member 42 is inclined by the rotation driving operation, a hold amount of ink that can be held by the cap member 42 (a hold amount of fluid) is changed. Ink having an amount exceeding the hold amount of ink drops so that the peripheral portion 40a of the rotary body 40 is contaminated. The hold amount of ink is determined depending on a height of an edge of the cap member 42, a specific gravity of ink or a surface tension thereof. When the cap member 42 has an ink absorption material 42b such as a sponge or a non-woven cloth, the hold amount of ink is determined depending on a capillary force. In the fourth embodiment, by controlling the suction amount on the basis of the hold amount of ink, the suction amount is controlled to be an adequate amount by which ink does not drop from the cap member 42. With the above configuration, it is possible to prevent ink from dropping without excessively driving the suction pump 45. Accordingly, it is possible to improve the durability of the suction pump 45.

Thus, while the preferred embodiments of the invention are described with reference to the drawings, the invention is not limited to the embodiments. The shapes or combinations of the structural components or members in the embodiments are exemplarily shown and can be modified in accordance with a design demand or the like without departing from the scope or spirit of the invention.

Note that while the ink jet printer is described as an example of the fluid ejecting apparatus in the above embodiment, it is not limited thereto. An apparatus such as a copier or a facsimile machine can be used.

In addition, in the above embodiment, the fluid ejecting apparatus that ejects fluid (a liquid medium) such as an ink is exemplarily described. However, the invention can be applied to a fluid ejecting apparatus that ejects fluid except ink. As fluid that can be ejected from the fluid ejecting apparatus, fluid, a liquid medium containing particles of a functional material dispersed or dissolved therein, a gel-like granular material, a solid that is flowable and ejectable as fluid and particles (toner or the like) are given.

In the above embodiments, not only ink but also fluid corresponding to a specific application can be used as fluid (a liquid medium) to be ejected from the fluid ejecting apparatus. The fluid ejecting apparatus is provided with an ejection head that can eject fluid corresponding to the specific application. The ejection of the fluid corresponding to the specific application from the ejection head causes the fluid to adhere to a predetermined object, thereby producing a predetermined device. For example, the fluid ejecting apparatus (the liquid medium ejecting apparatus) according to the invention can be applied to a fluid ejecting apparatus that ejects fluid (a liquid medium) obtained by dispersing (dissolving) a material such as an electrode material or a colorant into a predetermined dispersion medium (a solvent), the electrode material or the colorant being used for manufacturing a liquid crystal display, an EL (electro luminescence) display and an field emission display (FED).

In addition, it is possible to apply the invention to a fluid ejecting apparatus that ejects a living organic material used for producing a bio-chip or a fluid ejecting apparatus that ejects fluid to be a specimen used as a precise pipette. Further, it is also possible to list up a fluid ejecting apparatus for ejecting a grease to a precision machine such as a watch or a camera in a pinpoint manner, a fluid ejecting apparatus for ejecting on a substrate a liquid of a transparent resin such as an ultraviolet curable resin in order to form a fine hemispheric lens (optical lens) to be used for an optical communication element, a fluid ejecting apparatus for ejecting an acid or alkaline etching liquid for etching a substrate, a fluid medium ejecting apparatus for ejecting a gel, and a toner ejecting type recorder for ejecting a solid material such as fine particles like toner. Namely, the invention can be applied to either one of the above fluid ejecting apparatuses.

The entire disclosure of Japanese Patent Application Nos. 2009-120229, filed May 18, 2009, 2009-242511, filed Oct. 21, 2009 are expressly incorporated by reference herein.

What is claimed is:

1. A method for maintaining a fluid ejecting apparatus that includes a fluid ejection head that ejects fluid onto a medium; a rotary body that is provided with a fluid reception member that receives the fluid and a medium support member that supports the medium, and is rotatable around a shaft extending in a direction perpendicular to an ejecting direction of the fluid; a rotation driving device that drives and rotates the rotary body and moves the fluid reception member from a fluid reception position where the fluid reception member faces the fluid ejection head to a fluid non-reception position where the fluid reception is retracted from the fluid reception position; and a suction device that sucks the fluid in the fluid reception member, the method comprising:
synchronizing a driving operation of the rotation driving device with a driving operation of the suction device.

2. The method for maintaining a fluid ejecting apparatus according to claim 1, wherein
the rotation driving device is driven in association with the driving operation of the suction device in the synchronizing.

3. The method for maintaining a fluid ejecting apparatus according to claim 2, wherein
the rotation driving device is driven after driving the suction device in the synchronizing.

4. The method for maintaining a fluid ejecting apparatus according to claim 2, wherein
the suction device and the rotation driving device are concurrently driven in the synchronizing.

5. The method for maintaining a fluid ejecting apparatus whose fluid non-reception position of the fluid ejecting apparatus is at a position where the fluid reception member faces vertically downward according to claim 2, wherein
the suction device is driven until the driving operation of the rotation driving device is completed in the synchronizing.

6. The method for maintaining a fluid ejecting apparatus according to claim 1, wherein
the rotation driving device is driven after completing the driving operation of the suction device in the synchronizing.

7. The method for maintaining a fluid ejecting apparatus according to claim 1, further comprising:
controlling an amount of suction performed by the suction device on the basis of an amount of fluid held by the fluid reception member that varies with the driving operation of the rotation driving device.

8. The method for maintaining a fluid ejecting apparatus according to claim 1, further comprising:
measuring an amount of the fluid in the fluid reception member; and
secondarily controlling an amount of suction performed by the suction device on the basis of a measurement result obtained in the measuring.

9. A fluid ejecting apparatus comprising:
a fluid ejection head that ejects fluid onto a medium;
a rotary body that is provided with, at an outer peripheral portion thereof, a fluid reception member that receives the fluid and a medium support member that supports the medium, and is rotatable around a shaft extending in a direction perpendicular to an ejecting direction of the fluid;
a rotation driving device that drives and rotates the rotary body and moves the fluid reception member from a fluid reception position where the fluid reception member faces the fluid ejection head to a fluid non-reception position where the fluid reception is retracted from the fluid reception position;
a suction device that sucks the fluid in the fluid reception member; and
a synchronization device that synchronizes a driving operation of the rotation driving device with a driving operation of the suction device.

10. The fluid ejecting apparatus according to claim 9, wherein
the synchronization device includes a driving force transmission device that transmits a driving force of a rotation driving source of the rotation driving device to the suction device so as to drive the suction device.

11. The fluid ejecting apparatus according to claim 10, wherein
the driving force transmission device includes
a drive gear that is engaged with and rotated by the rotation driving source,
a first follower gear that is engaged with the drive gear and is followably rotated so as to be displaced between a driving force transmission position where a driving force is transmitted to the rotation driving device and a driving force non-transmission position where the first follower gear is retracted from the driving force transmission position, and
a second follower gear that is engaged with the drive gear and is followably rotated so as to be displaced between a driving force transmission position where a driving force is transmitted to the suction driving device and a driving force non-transmission position where the second follower gear is retracted from the driving force transmission position.

12. The fluid ejecting apparatus according to claim 11, wherein
the driving force transmission device includes a coupling member that couples the first follower gear and the second follower gear with each other in such a manner that a relative distance between the first follower gear and the second follower gear in a circumferential direction of the drive gear is made to be constant.

13. A fluid ejecting apparatus comprising:
a fluid ejection head that ejects fluid onto a medium;
a rotary body that is provided with a fluid reception member that receives the fluid and a medium support member that supports the medium at an outer peripheral portion thereof, and is rotatable around a shaft extending in a direction perpendicular to an ejecting direction of the fluid;
a suction device that sucks the fluid in the fluid reception member;
a drive gear that is coupled with a rotation driving source and is rotated so as to function as a sun gear;
first and second follower gears functioning as planetary gears;
a rotary body gear that transmits a driving force to the rotary body;
a suction pump gear that transmits a driving force to the suction device;
a first transmission gear train having one or more gears; and
a second transmission gear train having one or more gears, wherein
when the drive gear is rotated in one direction, the first follower gear transmits a driving force to the rotary body gear and the second follower gear transmits a driving force to the suction pump gear via the second transmission gear train,
when the drive gear is rotated in the other direction, the second follower gear does not transmit a driving force to the rotary body gear and the first follower gear transmits a driving force to the suction pump gear via the first transmission gear train, and
one of the number of gears of the first transmission gear train and the number of gears of the second transmission gear train is an odd number, and the other number is an even number.
